(19) United States
(12) Patent Application Publication
(10) Pub. No.: US 2006/0087527 A1
(43) Pub. Date: Apr. 27, 2006

(54) Method for preparing a print mask

(76) Inventors: Alejandro Manuel de Pena, Sant Cugat del Valles (ES); Joan Manuel Garcia, Sant Cugat (ES); Santiago Garcia Reyero, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/974,370

(22) Filed: Oct. 27, 2004

(51) Int. Cl. B41J 29/38

(52) U.S. Cl. 347/12; 347/14

(57) ABSTRACT

A method for preparing a mask for multi-pass printing, comprises determining a characteristic satellite drop spray pattern for printing in a multi-pass mode with a printhead. Positions in the mask are filled with pass numbers. The pass numbers in a given position are selected based on considerations of interactions among main drops and satellite drops.

### BACKGROUND OF THE DISCLOSURE

In an ink-jet printer, droplets of ink or colorant are ejected through orifices and onto a printing medium in a two-dimensional pixel array to form an image. In a multi-pass print mode, the printhead may eject droplets from certain of the orifices on a given pass and from certain of the other orifices on subsequent or earlier passes. The overall pattern, size, timing and spacing of individual ink droplets or drops ejected from the ink-jet printer and printed within a given area of the media can affect the print quality of the image.

Print masks may be generated for given printheads operating in given print modes to control the particular pass of a multi-pass printmode in which a particular orifice corresponding to a particular pixel or cell in the image will be ejected. The print mask may be represented by an array of numbers, each one over a pixel, that represents the number of the pass (for example 1 through 8 in an 8-pass printmode) in which that pixel will be printed. In a dither mask, each value in the print mask represents a discriminator against which input levels are to be tested. Print masks can be generated incrementally using a matrix-based masking process which is based on various spatial and temporal constraints. Commonly assigned U.S. Pat. No. 6,542,258, for example, describes using a constraint matrix to generate a print mask.

Some printheads create characteristic “satellite” droplets which land in a consistent relation to the main drop being ejected. Satellite droplets may adversely affect image quality. Although the image effects due to a satellite may be less noticeable where the number of passes is high, in the case of print modes with fewer passes, the effects may be increased. In addition, where the size of satellite drop is large with respect to the main drop, the effects of satellite drops may be more visible.

### BRIEF DESCRIPTION OF THE DRAWINGS

Features and advantages of the disclosure will be readily appreciated by persons skilled in the art from the following detailed description of exemplary embodiments thereof, as illustrated in the accompanying drawings, in which:

FIG. 1 illustrates exemplary dots ejected from a printhead onto a print medium.

FIG. 2 illustrates an exemplary embodiment of a print mask.

FIG. 3 illustrates an exemplary embodiment of a constraint matrix.

FIG. 4A illustrates an exemplary embodiment of a print mask with one unfilled position.

FIG. 4B illustrates an exemplary embodiment of a print mask with an exemplary embodiment of a constraint applied to the print mask.

FIG. 5 illustrates an exemplary embodiment of a partially filled out print mask.

FIG. 6 illustrates the exemplary, partially filled out print mask of FIG. 5 with an exemplary constraint matrix applied to a position to be filled in.

FIGS. 7A-7E illustrate the exemplary, partially filled out print mask of FIG. 5 with an exemplary constraint matrix applied to positions of the print mask which have already been filled in.

FIG. 8 illustrates the exemplary, partially filled out print mask of FIG. 5 with an additional position filled out.

FIG. 9 illustrates an exemplary method of generating a print mask.

FIG. 10 illustrates an exemplary embodiment of a printer.

FIG. 11 illustrates an exemplary plan view of an orifice plate.

FIG. 12 illustrates an detail view of exemplary embodiment of the orifice plate of FIG. 11.

FIG. 13 an exemplary block diagram of elements of an embodiment of a printing system.

### DETAILED DESCRIPTION OF THE DISCLOSURE

In the following detailed description and in the several figures of the drawing, like elements are identified with like reference numerals.

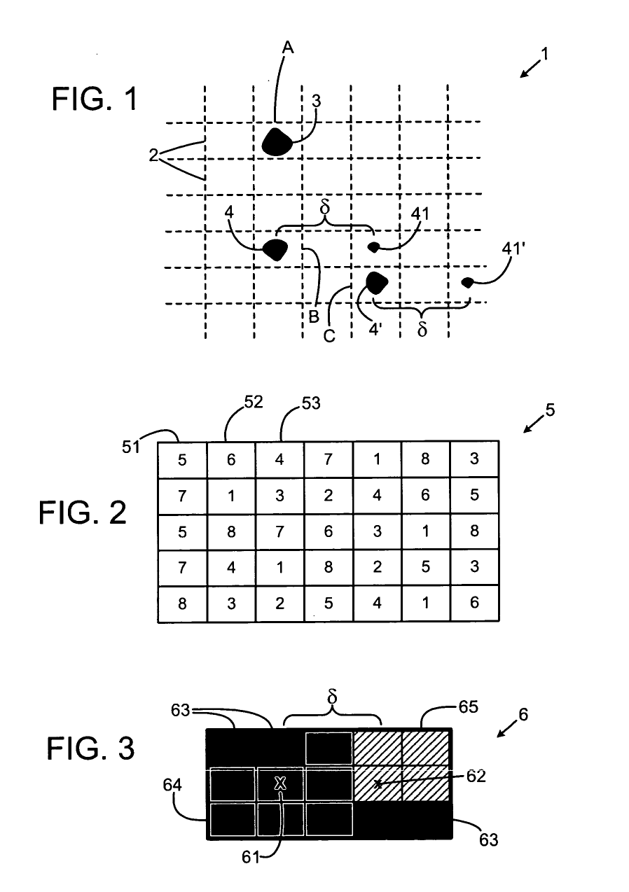

FIG. 1 illustrates a grid 1 in which each square represents the location of a pixel or cell 2 in an image. In a 600 dpi printer, for example, each cell may be about 1/600^{th} of an inch in length or about 40 um. Each cell represents the location where a drop may be ejected in printing an image. A printer may be designed with the intent of normally ejecting one droplet at one corresponding cell or pixel when a given ink ejection orifice or nozzle is fired. Droplet 3 in cell A, for example, represents a drop that was fired from an orifice when the printer signaled its corresponding nozzle or orifice to fire.

In some cases, due to the interaction of various factors which may include nozzle size and geometry, orifice plate and orifice surface characteristics, fluid characteristics, firing speed, speed of travel of the printer carriage and/or other factors which may be present, one or more “satellite” drops or droplets result from the firing of an orifice. Droplets 4 and 41, for example, represent a main drop 4 and a satellite drop 41 which resulted from the firing of the orifice corresponding to pixel B. The satellite has a separation δ from the main drop, where δ represents both the direction and distance from the main drop. In the example illustrated in FIG. 1, the satellite 41 is located in the same row and two columns to the right from the pixel B where the main drop 4 was printed. In an exemplary embodiment, the satellite drop 41 may be smaller than, be less visible than or be less perceptible than the main drop 4. In other exemplary embodiments, the satellite drop 41 may be nearly equal, equally or greater in size, visibility or perceptibility as the main drop 4, or be as visible or perceptible. In an exemplary embodiment, if satellite drops 41 are created with sufficient size, visibility or perceptibility, the cumulative effect of the satellite drops 41 on an image may have an effect on the image quality.

In an exemplary embodiment, for a given printhead, printhead design, or printhead architecture, the printhead may eject satellites from all or most of the orifices in a predictable, characteristic manner. In other words, on the average, each orifice can be expected to eject a satellite with the similar relative size, visibility or perceptibility and a mean displacement δ from its corresponding main droplet. In FIG. 1, for example, main drop 4′ and satellite drop 41′ are separated by about the same displacement δ as are main drop 4 and satellite 41. The size, shape and displacement of a satellite from the main drop may depend, for example, on the pen to paper spacing, the print velocity, the firing frequency, and/or the type of ink or colorant being used. The characteristic mean displacement δ may be derived from a general model or extracted from a calibration process on each individual printer.

For a given printhead design or specific printhead, information regarding the mean displacement δ for the characteristic satellite pattern can be developed by measuring the displacement of a satellite from the main drop. In an exemplary embodiment, this can be done for a given architecture or even a specific pen. For example, the mean displacement can determined by running a series of tests, analyzing the spray patterns and droplets produced by the printhead using various speeds, modes, inks and colorants. The tests can be performed on a number of similarly designed printheads and the results can be analyzed using statistical or other methods to determine the characteristic, expected satellite patterns for the printhead.

In an exemplary embodiment, a printer will eject droplets in a pattern on a print medium to form an image. The printer controller causes the printer to deposit the droplets in particular locations, cells or pixels so that the printed image will be reflective of image data to be printed. In a multi-pass printmode, a controller may control the individual orifices in a printhead to fire during particular passes of the printhead in accordance with a printmask.

FIG. 2 illustrates an exemplary embodiment of a printmask 5. In an exemplary embodiment, a printmask may be in the form of a matrix wherein each position in the matrix corresponds to a pixel to be printed. The matrix is filled with numbers representing the pass number, of a multi-pass printmode, in which a particular pixel is to be allowed to fire. The exemplary embodiment of FIG. 2 illustrates a printmask for an eight pass print mode. The first pixel 51 in the first row will be fired in the fifth pass, the next pixel to the right 52 in the sixth, the next pixel 53 in the fourth pass and so on. In an exemplary embodiment, a print mask may be cyclical in its vertical and horizontal dimension across an image.

In an exemplary embodiment, a method for generating the print mask 5 incorporates the effect of satellites 41, 41′ (FIG. 1) on an image. in an exemplary embodiment with satellite drops of sufficient size and frequency, the satellite drops may introduce similar image quality factors as exist with respect to the printing of main drops. For example, it may be desirable to eject drops to ensure that drops printed on one pass have had adequate time to dry before another overlying pass is made in which a satellite or main drop lands within the same or neighboring printed area as a previously printed main or satellite droplet. Non-uniform or inconsistent drying may cause undesirable print quality effects including beading, bleeding and coalescence. In FIG. 1, for example, it may be desirable to print the pixel B in which the main drop 4 is printed on a different pass from the pass from pixel C in which the pixel 4′ is printed, because of the proximity of the satellite drop 41 to the main drop 4′.

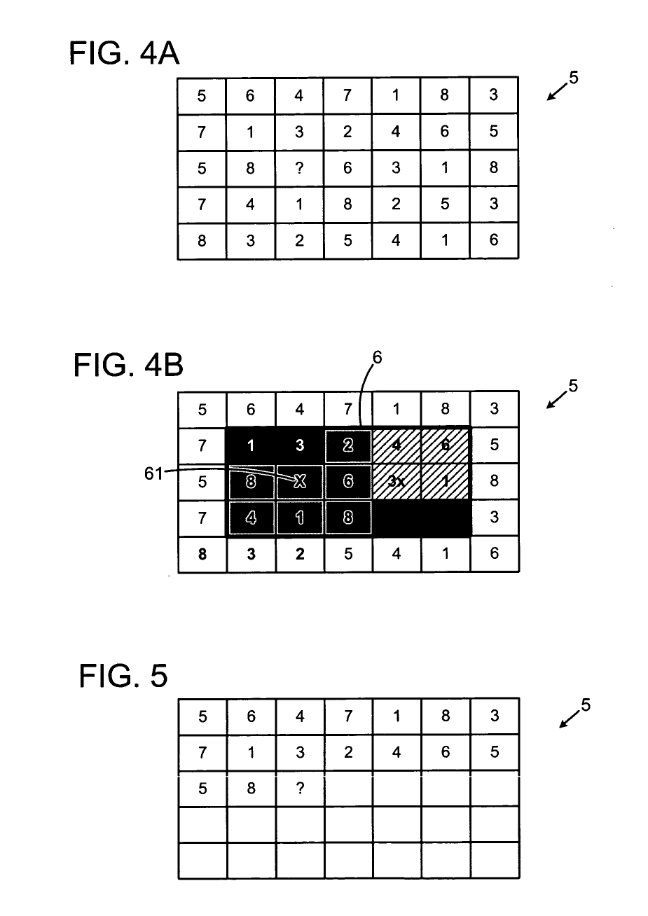

Factoring in constraints derived from considering the effect of neighboring satellites on image quality, in addition to the effect of main drops, may better approximate real pattern printing and improve image quality by further reducing the interaction among individual main drops and their satellites while they are drying. FIG. 3 illustrates a graphic representation of an exemplary embodiment of a constraint matrix 6 for use in building a print mask 5 (FIG. 4A) for a multi-pass print mode. The constraint matrix 6 comprises a first “pivot point” 61 (marked with an upper case X), corresponding to a main drop 4, 4′ (FIG. 1) to be ejected, and a second “pivot point” 62 (marked with a small case x) corresponding to an expected, characteristic satellite droplet 41, 41′ to be ejected at the same time as the main drop. Such a constraint matrix will take into account the effects of satellite drops on an image.

The constraint matrix of FIG. 3 can alternately be represented as:

$$[ C ] = [ \begin{matrix}0 & 0 & 1 & {1}_{W} & {1}_{W} \\ 1 & X & 1 & {1}_{X} & {1}_{W} \\ 1 & 1 & 1 & 0 & 0\end{matrix} ]$$

The print mask is generated by placing the pivot point 61 over a grid position of the print mask, and the other constraint matrix positions over corresponding other positions of the print mask, and determining a valid or best pass for printing the X pixel, in view of the constraints placed on the X pixel and the passes in which cells under the constraints are to be printed. In the exemplary embodiment of FIG. 3, the zero weights 63 (shown in black in FIG. 3) represent neighbors that do not place any constraints on the X pixel. The main constraints 64 (shown in grey in FIG. 3) include ‘1’ constraints, representing constraints on the X pixel imposed by neighboring pixels. The ‘1’ constraints represent pixels which constrain the X pixel by having to be printed in a pass which is at least one pass earlier or later than the pass in which the X pixel is printed—in other words, they cannot be printed during the same pass. The satellite constraints 65 (cross-hatched in FIG. 3) impose weighted constraints 1_{w} and 1ₓ correspond to constraints placed on firing the orifice corresponding to the X position, which result from taking into consideration the simultaneous ejection of a satellite drop at satellite position x. In other words, whereas the constraints on the main drop restrict printing of the main drop, based on various considerations affecting the image which may be caused by printing neighboring pixels with main drops which are too close in time to each other, the satellite constraints introduce additional levels of constraint, based on the desire to avoid effects caused by satellite drops which are printed too near in space and/or time to a pixel in which a neighboring pixel is printed. In an exemplary embodiment, the number of constraints to be considered may be limited so that adequate degrees of freedom remain to ensure that a program or controller implementing the constraint matrix to generate a print mask can find a solution in substantially each attempt.

In an exemplary embodiment, the satellite constraints 65 may be weighted by a number between 0 and 1 which is representative of the relative size of the satellite or its affect on the image. The weighted satellite constraints introduce constraints which take into account effects which may be caused by the presence of the satellite on a given pass. The constraints may be weighted less than the main constraints because the satellite may be smaller or less important to the image than the main droplet. In an exemplary embodiment, the weighting of the satellite pivotal point with respect to the main pivot point is indicative of the relative degree of forbiddance imposed by the satellite and may reflect its physical properties to some degree. For example, for very small satellites, the weighting may be very small. As the satellite size becomes relatively larger, the weighting may be correspondingly larger. Where a satellite is the same size as the main drop, then the satellite constraints may be given equal weight as the main constraints.

In order to calculate the best pass for a given mask position, constraints are applied not only to any neighbor of the main pivot point 61 in the mask, but also to any neighbor of a second pivot point 62, that is displaced by the mean displacement δ with respect to the pivot point corresponding to the main drop. In an exemplary embodiment, the δ may be dependent on the direction in which a given pass is printed. In order to include the relative sizes of the main drop and the satellite drop, the constraints are applied to the pivot point and its shifted replica with relative weights that reflect this size difference.

In an exemplary embodiment, a print mask may be generated sequentially along rows for successive columns. The print mask values may be selected randomly from passes which are not constrained by the constraint matrix. In an exemplary embodiment, the print mask value for a new position to be filled is determined by applying the constraint matrix to the print mask with the main pivot point 61 over the next position to be filled. In an exemplary embodiment, the main constraints and the satellite constraints are applied to determine the passes in which the pixel corresponding to the position to be filled should not be printed and the passes in which it is undesirable or less desirable to print the pixel. Then, the pass in which to print the pixel may be selected from among the otherwise allowable passes which are not constrained or otherwise undesirable.

In an exemplary embodiment, when no allowable passes can be found, the relative weights of the main constraints and satellite constraints may be used to determine the best pass for printing a particular pixel. In the exemplary embodiment of FIG. 3, the constraints are represented as simple 1 or zero constraints. In other exemplary embodiments, the main constraints may be weighted constraints.

FIG. 4A illustrates an exemplary print mask 5 with one, unfilled position ‘?’. FIG. 4B illustrates the exemplary embodiment of FIG. 4A with the main pivot point 61 of the constraint matrix of FIG. 3, superimposed or applied to the print matrix position ‘?’. Based on the ‘1’ constraints in the main constraint positions 64 (FIG. 3) of the constraint matrix 6, the pass numbers 2, 8, 6, 4, 1, and 8 (in the grey boxes) are not “legal” pass numbers for printing the X pixel. In other words, the constraints forbid the printing of the X pixel in the same pass as the constrained pixels. The pass numbers in the cross-hatched satellite constraint positions 65 (FIG. 3), namely the pass numbers 4, 3, 6, 1, are undesirable under the weighted satellite constraints. The remaining legal numbers, based on the main constraints, include 3, 5 and 7. Of those, the pass number 3 is considered undesirable based on the satellite constraints. Accordingly, the best numbers for the pass in which the ‘?’ should be printed are pass 5 or 7. In an exemplary embodiment, a print mask position may be selected randomly from among ‘legal’ or desirable numbers. In an exemplary embodiment, the print pass number for a given printmask position may be selected according to some other standard or condition. For example, in the example of FIG. 3, the number 7 might be selected as the best because a 5 is already in the same row.

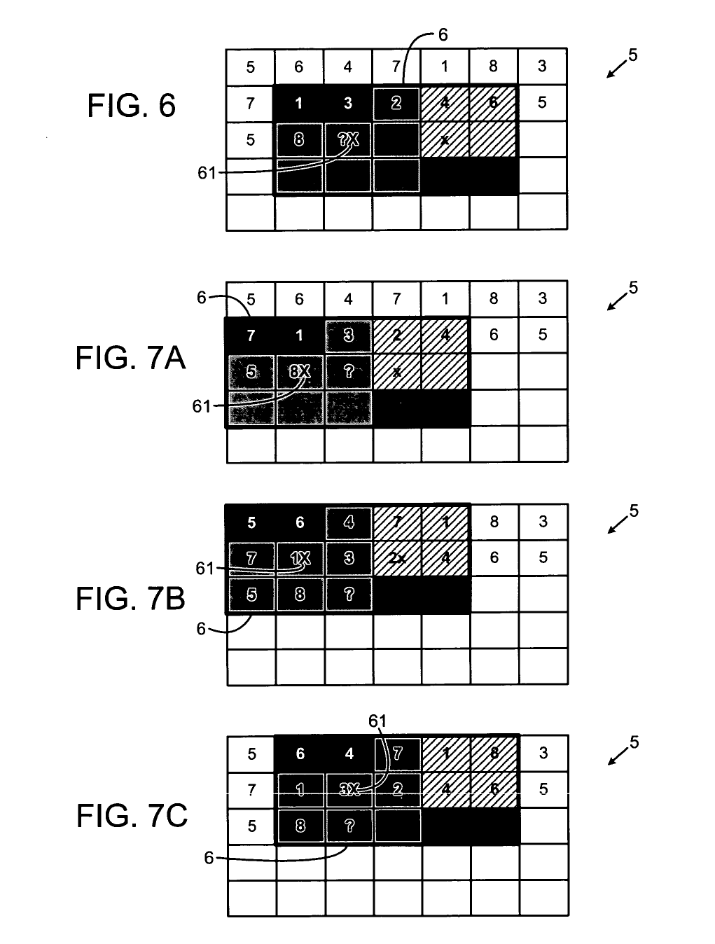

FIG. 5 illustrates an exemplary partially generated or constructed print mask 5 for which the print mask pass values have been partially filled-in. The exemplary print mask has been filled in through the first two rows and the first two positions of the third row, from the left. FIG. 6 illustrates the printmask 5 of FIG. 5 with the constraint matrix 6 of FIG. 3 applied to the printmask. The main pivot point 61 (X) is placed over the next printmask position to be filled—‘?’. The main constraints (shaded grey) show that the numbers 2 and 8 are forbidden and the cross-hatched, satellite constraints show that the numbers 4 and 6 are undesirable. Numbers that are still available include 1, 3, 5 and 7.

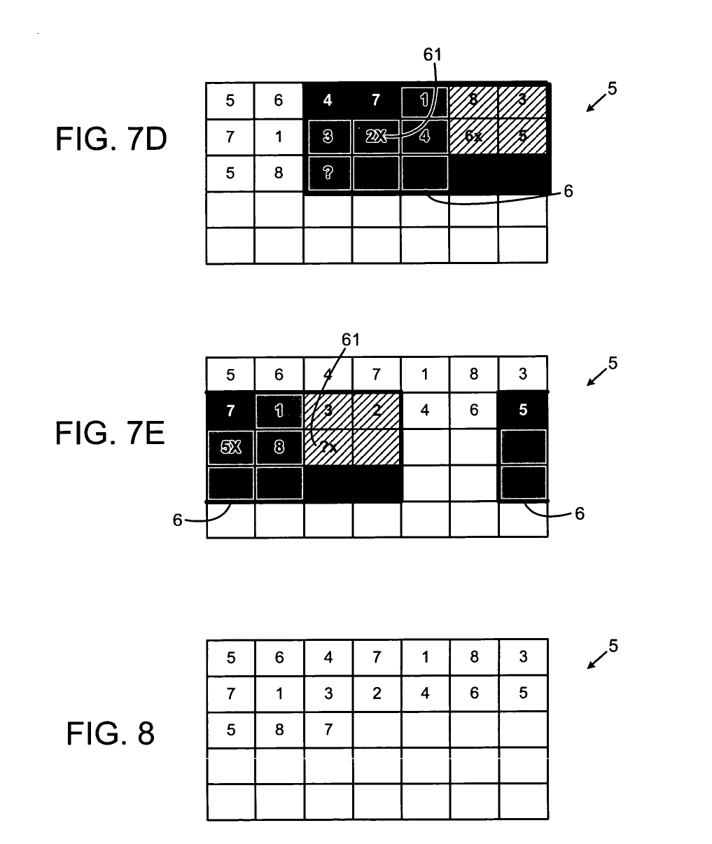

In an exemplary embodiment, placing a number in a printmask may not only use an allowed, available, unconstrained number, but may also ensure that previously filled-in positions remain legal. In other words, the print mask values may have forward compatibility and backward compatibility with the constraint matrix. In an exemplary embodiment, this can be tested by applying the constraint matrix back over the previously filled-in positions. FIGS. 7A-E, for example, show the main pivot point 61 (X) position of the constraint matrix applied to positions which have already been filled and which would be constrained to some degree by the position—‘?’—to be filled. The position to be filled, the ‘?’ position, constrains each of the four, adjacent, already-filled-in positions, as shown in FIGS. 7A-7D. Accordingly, the ‘?’ position cannot be filled in with a 1 (FIG. 7B), 2 (FIG. 7D), 3 (FIG. 7C) or 8 (FIG. 7A) if each of those positions are to continue being legal after filling in the new position. In addition, placing the constraint matrix over the position two positions to the left from the “?” position (FIG. 7E) shows that it would be undesirable for the newly-filled position to be a 5, as shown in FIG. 7E. Taking into account the application of the constraint matrix to the position to be filled and checking the legality of the available passes against the already-filled in positions, numbers 1, 2, 3 and 8 are forbidden and 4, 5 and 6 are undesirable. Accordingly, the only available and not undesirable number is 7. FIG. 8 illustrates the print mask with the new position filled with the 7.

FIG. 7E illustrates an exemplary embodiment in which the constraint matrix is a “circular” condition when applied to the print mask. When the constraint matrix is applied to the right side of the print mask, such that the constraint matrix extends beyond the edge of the print mask, the constraint matrix wraps around to the opposite edge of the print mask. This is the case because, in an exemplary embodiment, the print mask may be repetitive both across and up and down the print head. In otherwords, the order in which the various pixels are printed relative to the pixels in its immediate vicinity is repeated across the image for the entire width of the image and down the entire length of the image. In an exemplary embodiment, the size of a printmask may be a design choice which may depend, at least in part, on memory requirements and the available amount of memory. In an exemplary embodiment, a small, low-cost printer may have relatively low available memory and a corresponding relatively smaller print mask—for example 16×16. In an exemplary embodiment, a large format printer with sufficient available memory may have a printmask adapted to the printhead size, which may reduce masking artifacts. For example, a printhead with 512 nozzles may have a 512×384 printmask.

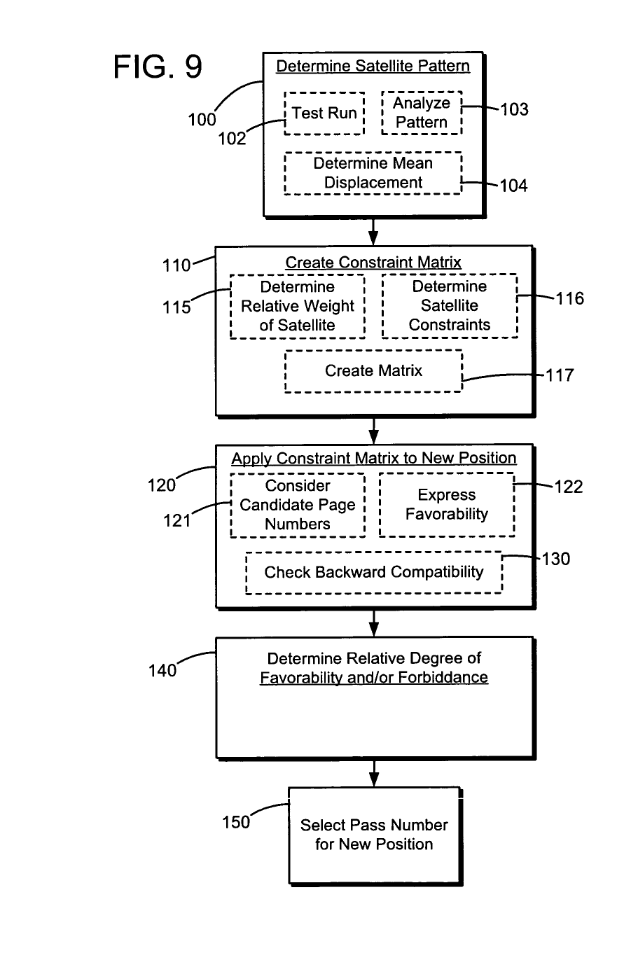

FIG. 9 illustrates an exemplary method for constructing or generating a print mask. In an exemplary embodiment, the method comprises first determining 100 a satellite pattern for a printhead, creating 110 a constraint matrix with main constraints and satellite constraints, applying 120 the constraint matrix to a print mask with the main pivot point at the position to be filled, determining 140 the allowability, non-allowability and/or relative degree of forbiddance or favorability for pass numbers at the position to be filled, and selecting 150 a pass number for filling the position in the print mask to be filled.

In an exemplary embodiment, determining a satellite pattern for a printhead comprises performing test runs 102, analyzing 103 spray patterns and determining 104 a mean displacement of a characteristic satellite drop or drops. In an exemplary embodiment, creating 110 a constraint matrix comprises determining 115 the relative weight to be given to satellite constraints, for example based on the size of a characteristic satellite, determining 116 constraints imposed by the satellite drops, and creating 117 a matrix representative of constraints imposed on a main pivot point based on positions neighboring the main pivot point and representative of constraints imposed on the main pivot point based on positions neighboring a secondary pivot point corresponding to a satellite drop.

In an exemplary embodiment, applying 120 the constraint matrix to a new position to be filled in the print mask comprises considering 121 candidate pass numbers, for a particular position in the mask, and expressing the favorability 122 of each candidate pass number, with regard to each of plural positions neighboring the main drop and with regard to each of plural positions neighboring the satellite drop in the form of respective weights. In an exemplary embodiment, applying constraint matrix to a new position also comprises checking 130 the backward compatibility of candidate pass numbers by placing the constraint matrix over positions which have already been filled 130, and determining the favorability of candidate pass numbers, in part, on a desire to have previously filled in pass numbers remain “legal” under their constraints after filling in the new number.

In an exemplary embodiment, producing a printmask by applying 120 the constraint matrix to the print mask with the main pivot point at the position to be filled may produce a first order of a print mask. Checking 130 the backward compatibility of a candidate pass number may result in a printmask with improved print quality with respect to the first order printmask. In an exemplary embodiment, checking 130 the backward compatibility may be omitted where the first order printmask results in satisfactory print quality or where the improvement over the first order printmask is small.

In an exemplary embodiment, determining 140 allowed, not allowed, and or relative degree of forbiddance or favorability for pass numbers at the particular location comprises consolidating the weights to obtain a measure of favorability for each candidate pass number. The new position is filled with a pass number by selecting 150 a pass number for the position from among the candidate pass numbers based on the measure of favorability. In an exemplary embodiment, this process is repeated for each position in the mask.

In an exemplary embodiment, a multi-pass print mode comprises a bidirectional print mode. In other words, the printhead may move in one direction, for example a right-to-left direction, on some of the passes and in another direction, for example a left-to-right, on other passes. In an exemplary embodiment, the mean displacement _67 while printing in one direction may be different, either in magnitude or direction, from the mean displacement δ when printing in the other direction. In such embodiments, unique constraint matrices may be developed reflecting the different mean displacement δ and/or the different relative size and corresponding weights of the constraints for printing in each printing direction. For example, a right printing constraint matrix for determining the print mask values of rows printed in a right-moving direction and a left printing constraint matrix for use in determining the print mask values for rows printed in a left-moving direction. For each printing pass of a multi-pass, bi-directional print mode, only the corresponding weight values for the appropriate directional constraint matrix are applied to determine the print mask values for each cell or pixel.

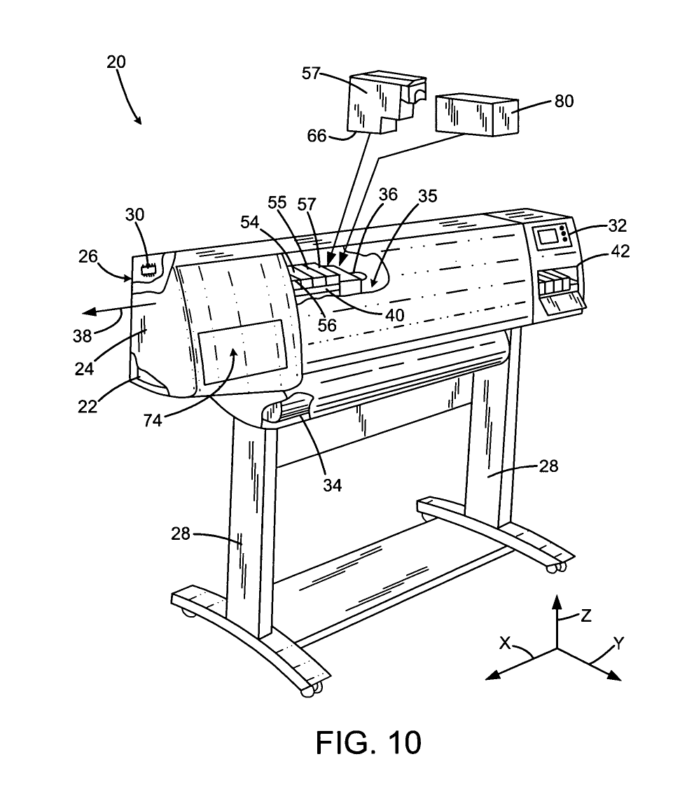

Embodiments of a print mask constructed or generated in accordance with exemplary methods described herein may be practiced in a variety of printers. FIG. 10 illustrates an embodiment of a printer 20, which may be used for recording information onto a recording medium, such as paper, textiles, and the like, in an industrial, office, home or other environment. For instance, it is contemplated that an embodiment may be practiced in large scale textile printers, desk top printers, portable printing units, copiers, cameras, video printers, and facsimile machines, to name a few.

While the printer components may vary from model to model, the printer 20 includes a chassis 22 surrounded by a housing or casing enclosure 24, together forming a print assembly portion 26 of the printer 20. In an exemplary embodiment, the print assembly portion 26 may be supported by a desk or tabletop, however; in the embodiment of FIG. 10, the print assembly portion 26 is supported with a pair of leg assemblies 28. The printer 20 also has a printer controller 30, illustrated schematically as a microprocessor, that receives instructions from a host device (not shown). In an exemplary embodiment, the host device may be, for example, a computer or a computer aided drafting (CAD) computer system. The printer controller 30 may also operate in response to user inputs provided through a key pad and a status display portion 32, located on the exterior of the casing 24. A monitor coupled to the host device may also be used to display visual information to an operator, such as the printer status or a particular program being run on the host device.

A recording media handling system may be used to advance a continuous sheet of recording media 34 from a roll through a print zone 35. Moreover, the illustrated printer 20 may also be used for printing images on pre-cut sheets, rather than on media supplied in roll 34. The recording media may be any type of suitable sheet material, such as, for example, paper, poster board, fabric, transparencies, mylar, vinyl or other suitable materials. A carriage guide rod 36 is mounted to the chassis 22 to define a scanning axis 38, with the guide rod 36 slideably supporting a carriage 40 for travel back and forth, reciprocally, across the print zone 35. A carriage drive motor (not shown) may be used to propel the carriage 40 in response to a control signal received from the controller 30.

The printer 20 of this exemplary embodiment includes four print cartridges 54-57. In the print zone 35, the recording medium receives ink from cartridges 54-57. The cartridges 54-57 are also often called “pens” by those in the art. One of the pens, for example pen 57, may be configured to eject black ink onto the recording medium, where the black ink may contain a pigment-based or a dye-based ink or other type of ink. Pens 54-56 may be configured to eject variously colored inks, e.g., yellow, magenta, cyan, light cyan, light magenta, blue, green, red, to name a few. For the purposes of illustration, pens 54-56 are described as each containing a dye-based ink of the colors yellow, magenta and cyan, respectively, although it is apparent that the color pens 54-56 may also contain pigment-based inks in some implementations. It is apparent that other types of inks may also be used in the pens 54-57, such as paraffin-based inks, as well as hybrid or composite inks having both dye and pigment characteristics.

The printer 20 of this exemplary embodiment uses an “off-axis” ink delivery system, having main stationary reservoirs (not shown) for each ink (black, cyan, magenta, yellow) located in an ink supply region 74. In this respect, the term “off-axis” generally refers to a configuration where the ink supply is separated from the print heads 54-57. In this off-axis system, the pens 54-57 may be replenished by ink conveyed through a series of flexible tubes (not shown) from the main stationary reservoirs so only a small ink supply is propelled by carriage 40 across the print zone 35 which is located “off-axis” from the path of printhead travel. As used herein, the term “pen” or “cartridge” may also refer to replaceable printhead cartridges where each pen has a reservoir that carries the entire ink supply as the printhead reciprocates over the print zone.

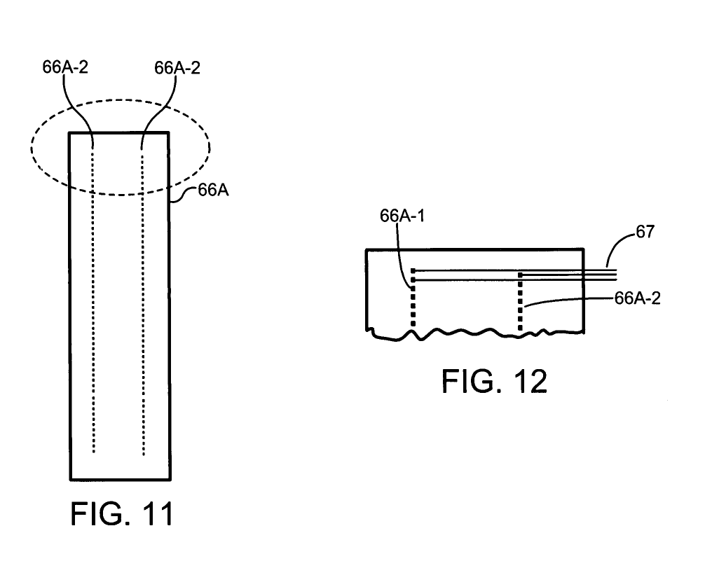

The illustrated pens 54-57 have printheads, e.g. printhead 66, which selectively eject ink to form an image on a sheet of media 34 in the print zone 35. In an exemplary embodiment, these printheads have a large print swath, for instance about 22.5 millimeters high or higher, although the concepts described herein may also be applied to smaller printheads. In an exemplary embodiment, the printheads each have an orifice plate with a plurality of nozzles formed there through. FIG. 11 shows in diagrammatic plan view an exemplary orifice plate or orifice layer 66A with a plurality of nozzles or orifices.

The nozzles of each printhead are typically formed in at least one, but typically two or more generally linear arrays along the orifice plate. For example, as shown in FIG. 11, the nozzles are formed in linear arrays 66A-1 and 66A-2. The term “linear” as used herein may be interpreted as “nearly linear” or substantially linear, and may include nozzle arrangements slightly offset from one another, for example, in a zigzag arrangement. Each linear array is typically aligned in a longitudinal direction substantially perpendicular to the scanning axis 38, with the length of each array determining the maximum image swath for a single pass of the printhead. The arrays can be staggered with respect to each other, so that an offset along the longitudinal direction enables higher resolution printing. For example, say the nozzles in array 66A-1 and array 66A-2 are spaced by 1/300 inch or 1/600 inch spacings. With the staggered array feature, the resolution can be increased to 1/600 or 1/1200, or to 600 dpi or 1200 dpi. FIG. 12 is an enlarged fragmentary view of the indicated region of FIG. 11, showing rows 67 printed by the staggered nozzles of the two arrays.

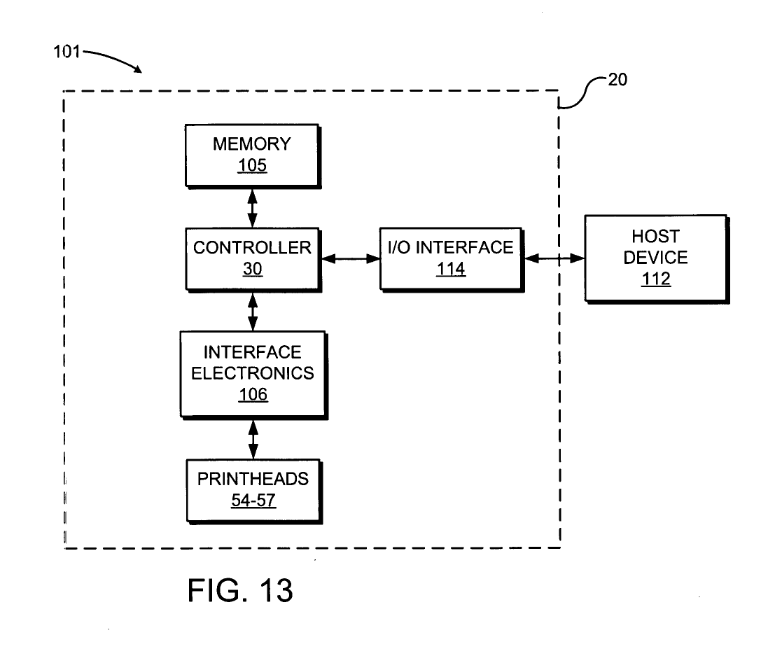

Referring to FIG. 13, there is illustrated an exemplary block diagram of elements of an embodiment of a printing system 101 comprising a printer 20 and a host device 112. The following description illustrates one exemplary manner in which a printer 20 may be operated. It is to be understood that the following description of FIG. 13 is but one manner of a variety of different manners in which such a printer 20 may be operated.

In the exemplary embodiment of FIG. 13, the printer 20 is shown as including four printheads 54-57. However, exemplary embodiments of print masks may be implemented on printers with fewer or more printheads.

The printer 20 may also include interface electronics 306 configured to provide an interface between the controller 30 and the components for moving the carriage 40, e.g., encoder, belt and pulley system (not shown), etc. The interface electronics 306 may include, for example, circuits for moving the carriage, the medium, firing individual nozzles of each printhead, and the like.

The controller 30 may be configured to provide control logic to implement programmed processes for the printer 20, e.g. to serve as a print engine, which provides the functionality for the printer. In this respect, the controller 30 may be implemented by a microprocessor, a micro-controller, an application specific integrated circuit (ASIC), and the like. The controller 30 may be a computer program product interfaced with a memory 105 configured to provide storage of a computer software, e.g. a computer readable code means, that provides the functionality of the printer 20 and may be executed by the controller. The memory 105 may also be configured to provide a temporary storage area for data/files received by the printer 20 from a host device 112, such as a computer, server, workstation, and the like. The memory 105 may be implemented as a combination of volatile and non-volatile memory, such as dynamic random access memory (“RAM”), EEPROM, flash memory, hard drive storage and the like. Alternatively the memory 105 may be included in the host device 112. In an exemplary embodiment, a print mask with print mask values reflecting constraints indicative of main drop considerations as well as constraints indicative of satellite drop considerations, may be implemented by or be stored in memory 105 and/or be implemented by the controller 30.

The controller 30 may further be interfaced with an l/O interface 114 configured to provide a communication channel between the host device 112 and the printer 20. The I/O interface 114 may conform to protocols such as RS-232, parallel, small computer system interface, universal serial bus, etc.

In an exemplary embodiment, a print mode is used to print an image. One of the parameters of the print mode is the number of passes needed to print the image. For an n-pass print mode the printer uses n passes to finish a given swath. This means that at every printing pass only one nth of the dots are being printed. The splitting of the image data in passes is done using a print mode mask. This mask contains the pass number when each pixel is going to be printed. In an exemplary embodiment, the print mask may be converted into ‘n’ separate, binary print mode masks, one for each pass, which are logically “anded” with the image data. If there is a ‘1’ value in the same position for the image and for the mask, a drop is going to be fired.

It is understood that the above-described embodiments are merely illustrative of the possible specific embodiments which may represent principles of the present invention. Other arrangements may readily be devised in accordance with these principles by those skilled in the art without departing from the scope and spirit of the invention.

What is claimed is:

1. A method for preparing a mask for multi-pass printing, comprising:
determining a characteristic satellite drop spray pattern for printing in a multi-pass mode with a printhead;
filling positions in a mask with pass numbers, wherein the pass numbers in a given position are selected based on considerations of interactions among main drops and satellite drops.

2. The method according to claim 1, wherein the considerations of interactions comprise at least one of drying time, non-uniform or inconsistent drying, beading, bleeding or coalescence.

3. The method of claim 1, further comprising:
determining a relative weight of a characteristic satellite drop;
determining satellite constraints;
creating a constraint matrix comprising satellite constraints weighted by the relative weight of the characteristic satellite;
applying the constraint matrix to a position to be filled the print mask;
determining the relative favorability of a candidate pass number;
filling the position to be filled with a pass number.

4. The method of claim 1, further comprising:
considering candidate pass numbers for a particular position in a mask;
expressing the favorability of each candidate pass number as main constraints and as satellite constraints, wherein the main constraints reflect considerations with regard to pass numbers in main neighbor positions or to be placed into main neighbor positions, wherein the main neighbor positions neighbor the particular position, and the satellite constraints reflect considerations with respect to pass numbers in satellite neighbor positions or to be placed into satellite neighbor positions, wherein satellite neighbor positions neighbor a satellite position corresponding to the particular position;
consolidating the constraints to obtain a measure of favorability for each candidate pass number;
selecting one of the candidate pass numbers for use at the particular position in the mask based on the measures of favorability.

5. The method according to claim 4, wherein the considerations of interactions comprise at least one of drying time, non-uniform or inconsistent drying, beading, bleeding or coalescence.

6. The method of claim 1, further comprising:
creating a constraint matrix comprising a first pivot point, corresponding to a main drop to be printed at a position, and comprising a second pivot point, corresponding to a satellite drop to be printed at a satellite position concurrently with the main drop, and comprising main constraints and satellite constraints;
applying the constraint matrix to the print mask to evaluate a relative favorability of a plurality of candidate pass numbers ; and
selecting a pass number for printing the position from among the candidate pass numbers, based at least in part on the relative degree of favorability of the candidate pass numbers.

7. The method according to claim 1, comprising:
providing a constraint matrix comprising a main pivot point, corresponding to a position-to-be-filled of a print matrix, a satellite pivot point, corresponding to a position of a satellite position, main constraints neighboring the main pivot point and satellite constraints neighboring the satellite pivot point.

8. A method for preparing a mask for multi-pass printing, comprising:
considering candidate pass numbers for a particular position in a mask;
expressing the favorability of each candidate pass number as main constraints and as satellite constraints, wherein the main constraints reflect considerations with regard to pass numbers in main neighbor positions or to be placed into main neighbor positions, wherein the main neighbor positions neighbor the particular position, and the satellite constraints reflect considerations with respect to pass numbers in satellite neighbor positions or to be placed into satellite neighbor positions, wherein satellite neighbor positions neighbor a satellite position corresponding to the particular position;
consolidating the constraints to obtain a measure of favorability for each candidate pass number;
selecting one of the candidate pass numbers for use at the particular position in the mask based on the measure of favorability.

9. The method according to claim 8, wherein the considerations of interactions comprise at least one of drying time, non-uniform or inconsistent drying, beading, bleeding or coalescence.

10. The method according to claim 8, wherein the main constraints reflect considerations of interactions of a first main drop to be printed in a first position with drops printed in positions neighboring the first position, and wherein the satellite constraints reflect considerations of interactions of a first satellite drop, to be printed concurrently with the first main drop at a first satellite position, with drops printed in positions neighboring the satellite position.

11. The method according to claim 8, wherein the satellite constraints are weighted, in part, based on a relative size, visibility or perceptibility of the satellite drop with respect to the main drop to be printed at the position-to-be-filled.

12. A method for preparing a mask for multi-pass printing, comprising:
determining a characteristic satellite pattern;
creating a constraint matrix comprising a first pivot point, corresponding to a main drop to be printed at a position, and comprising a second pivot point, corresponding to a satellite drop to be printed at a satellite position concurrently with the main drop, and comprising main constraints and satellite constraints;
applying the constraint matrix to the print mask to evaluate a relative favorability of a plurality of candidate pass numbers ; and
selecting the pass number for printing the position from among the candidate pass numbers, based at least in part on the relative favorability of the candidate pass numbers.

13. The method according to claim 12, wherein the considerations of interactions comprise at least one of drying time, non-uniform or inconsistent drying, beading, puddling or coalescence.

14. A method of preparing a print mask comprising:
determining a relative weight of a characteristic satellite drop;
determining at least a first satellite constraint;
creating a constraint matrix comprising the at least one satellite constraint, weighted by the relative weight of the characteristic satellite drop;
applying the constraint matrix to a position to be filled the print mask;
determining the relative favorability of at least one candidate pass number;
filling the position to be filled with the at least one pass number.

15. The method of claim 14, comprising determining the relative favorability of a plurality of candidate pass numbers;
determining the relative favorability of each of the plurality of candidate pass number; and
wherein the at least one candidate pass number is at least as favorable or more favorable than each of the plurality of candidate pass numbers.

16. A method of preparing a printmask comprising:
providing a first characteristic satellite drop pattern for printing in a first direction and determining a second characteristic satellite drop pattern for printing in a second direction;
providing a first constraint matrix comprising a first group of satellite constraints based on the first characteristic satellite drop pattern and providing a second constraint matrix comprising a second group of satellite constraints based on the second characteristic satellite drop pattern;
selecting pass numbers to fill positions in the printmask, wherein for a given position-to-be filled, the pass number is selected from a plurality of candidate pass numbers, each candidate pass number being associated with a corresponding one of the first or second direction, and wherein the favorability of each of the plurality of candidate pass numbers is determined by applying the one of the first or second constraint matrix that corresponds to the corresponding one of the first or second direction.

17. A mask for use in multi-pass printing, comprising:
a plurality of positions arranged in an array;
at least one pass number corresponding to each of the plurality of positions, wherein a first pass number in a first position meets a plurality of main constraints and satellite constraints of a constraint matrix, wherein the constraint matrix comprises a first pivot point corresponding to the first position, a second pivot point corresponding to a satellite position, main constraints in positions corresponding to neighboring positions which neighbor the first position and satellite constraints corresponding to satellite neighbor positions which neighbor the satellite position.

18. The print mask according to claim 17, wherein each of the at least one pass numbers corresponding to the plurality of positions meets the plurality of main constraints and satellite constraints of the constraint matrix with respect to the pass numbers of corresponding, respective neighboring positions and satellite neighbor positions.

19. A mask for use in multi-pass printing comprising:
an array of pass numbers corresponding to numbers of print passes in which corresponding, respective orifices of a printhead are to be fired, wherein each pass number is compatible with constraints of a constraint matrix, wherein the constraint matrix comprises a first pivot point corresponding to the first position, a second pivot point corresponding to a satellite position, main constraints in positions corresponding to neighboring positions which neighbor the first position and satellite constraints corresponding to satellite neighbor positions which neighbor the satellite position.

20. The mask of claim 19, wherein each pass number is compatible with constraints of a first constraint matrix for printing in a first direction and are compatible with constraints of a second constraint matrix for printing in a second direction.

21. A printer compising:
a controller for controlling a plurality of nozzles to eject drops of ink on particular ones of a plurality of passes;
a memory, wherein the memory holds a print mask, wherein the printmask comprises pass numbers determined based on main drop constraints and satellite drop constraints; and
wherein the controller controls the plurality of nozzles to eject drops of ink on passes based, at least in part, on the printmask.

22. The printer according to claim 21, wherein a plurality of the pass numbers were determined by applying a constraint matrix with a main pivot point and a satellite pivot point to the print mask.

23. The printer according to claim 21, wherein the controller comprises an application specific integrated chip (ASIC).

24. The printer according to claim 21, further comprising computer code stored in memory and arranged to implement the print mask; and
wherein the controller comprises a computer arranged to implement the computer code.

25. A print mask prepared in accordance with the method of claim 14.

26. A mask prepared in accordance with the method of claim 8.

27. An application specific integrated circuit comprising:
means for accessing a print mask stored in memory;
means for controlling the ejection of ink from nozzles of a printhead responsive to the print mask;
wherein the print mask comprises an array of pass numbers corresponding to numbers of print passes in which corresponding, respective orifices of a printhead are to be fired, wherein each pass number is compatible with constraints of a constraint matrix, wherein the constraint matrix comprises a first pivot point corresponding to the first position, a second pivot point corresponding to a satellite position, main constraints in positions corresponding to neighboring positions which neighbor the first position and satellite constraints corresponding to satellite neighbor positions which neighbor the satellite position.

28. The application specific integrated circuit (ASIC) of claim 27, wherein each pass number is compatible with constraints of a first constraint matrix for printing in a first direction and are compatible with constraints of a second constraint matrix for printing in a second direction.

29. Computer software, comprising:
computer readable code for accessing a print mask stored in memory;
computer readable code for controlling the ejection of ink from nozzles of a printhead responsive to the print mask;
wherein the printmask comprises an array of pass numbers corresponding to numbers of print passes in which corresponding, respective orifices of a printhead are to be fired, wherein each pass number is compatible with constraints of a constraint matrix, wherein the constraint matrix comprises a first pivot point corresponding to the first position, a second pivot point corresponding to a satellite position, main constraints in positions corresponding to neighboring positions which neighbor the first position and satellite constraints corresponding to satellite neighbor positions which neighbor the satellite position.

30. The computer software of claim 29, wherein each pass number is compatible with constraints of a first constraint matrix for printing in a first direction and are compatible with constraints of a second constraint matrix for printing in a second direction.
